(19) United States
(12) Patent Application Publication
(10) Pub. No.: US 2013/0315439 A1
(43) Pub. Date: Nov. 28, 2013

(54) METHOD FOR PROVIDING SERVICE USING IMAGE RECOGNITION AND ELECTRONIC DEVICE THEREOF

(71) Applicant: Samsung Electronics Co., Ltd., Suwon-si (KR)

(72) Inventors: Woo-Jong YOO, Hwaseong-si (KR); Ju-Pyo HONG, Suwon-si (KR)

(73) Assignee: Samsung Electronics Co., Ltd., Suwon-si (KR)

(21) Appl. No.: 13/900,258

(22) Filed: May 22, 2013

(30) Foreign Application Priority Data
May 23, 2012 (KR) 10-2012-0054910

(51) Int. Cl. G06K 9/62

(52) U.S. Cl. CPC G06K 9/6201
USPC 382/100

(57) ABSTRACT

A method for providing a service using an image recognition technology and an electronic device thereof are provided. The method for providing a service includes constructing a service screen, extracting an image from the service screen, determining personal information matching the extracted image, and executing an application program by using the personal information matching the image.

### PRIORITY

This application claims the benefit under 35 U.S.C. §119(a) to a Korean patent application filed in the Korean Intellectual Property Office on May 23, 2012 and assigned Serial No. 10-2012-0054910, the entire disclosure of which is hereby incorporated by reference.

### BACKGROUND OF THE INVENTION

1. Field of the Invention:

The present invention relates to an electronic device. More particularly, the present invention relates to an apparatus and method for providing a service using an image recognition technology in an electronic device.

2. Description of the Related Art:

Portable electronic devices are evolving into a form capable of providing not only a voice call service but also various services such as a message function, a wireless Internet function, a phonebook management function, a schedule management function, a memo management function, a navigation function and the like.

The inconvenience is that a user of the portable electronic device has to manipulate a menu many times so as to change a service. For example, when intending to send a message to a called electronic device during use of a Social Networking Service (SNS), the inconvenience is that the user of the portable electronic device terminates a social networking application program, and then executes a message sending application program. After that, the user of the portable electronic device directly inputs called electronic device information to the message sending application program to send a message. That is, the user must manipulate a plurality of menus while changing between services.

Therefore, a need exists for an improved apparatus and method for providing a supplementary service by interworking with a web based service in an electronic device.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to substantially address at least the above problems and/or disadvantages and to provide at least the advantages below. Accordingly, an aspect of the present invention is to provide an apparatus and method for providing a supplementary service by interworking with a web based service in an electronic device.

Another aspect of the present invention is to provide an apparatus and method for providing a service by using personal information matching an image of a web based service screen in an electronic device.

A further aspect of the present invention is to provide an apparatus and method for detecting an image in a web based service screen in an electronic device.

Yet another aspect of the present invention is to provide an apparatus and method for detecting an image in a region set by a user among a web based service screen in an electronic device.

Still another aspect of the present invention is to provide an apparatus and method for matching personal information to a specific image in an electronic device.

The above aspects are achieved by providing a method for providing a service using an image recognition technology and an electronic device thereof

According to an aspect of the present invention, a method for providing a service in an electronic device is provided. The method includes constructing a service screen, extracting an image from the service screen, determining personal information matching the extracted image, and executing an application program by using the personal information matching the image.

According to another aspect of the present invention, an electronic device is provided. The electronic device includes at least one processor for executing computer programs, a memory for storing data and instructions, and at least one program stored in the memory and configured to be executable by the at least one processor. The program constructs a service screen, extracts an image from the service screen, determines personal information matching the extracted image, and executes an application program by using the personal information matching the image.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram illustrating a construction of an electronic device according to an exemplary embodiment of the present invention;

FIG. 2 is a flowchart illustrating a procedure for providing a service by using personal information matching an image according to an exemplary embodiment of the present invention;

FIG. 3 is a flowchart illustrating a procedure for detecting an image in a web based service screen according to the first exemplary embodiment of the present invention;

FIG. 4 is a flowchart illustrating a procedure for detecting an image in a web based service screen according to the second exemplary embodiment of the present invention;

FIG. 5 is a flowchart illustrating a procedure for generating personal information about an image included in a web based service screen according to an exemplary embodiment of the present invention;

FIG. 6 is a flowchart illustrating a detailed procedure for generating personal information about an image included in a web based service screen according to an exemplary embodiment of the present invention;

FIG. 7 is a flowchart illustrating a procedure for starting a service for personal information by using macro information according to an exemplary embodiment of the present invention;

FIGS. 8A to 8C are diagrams illustrating a screen construction for detecting an image in a web based service screen according to an exemplary embodiment of the present invention;

FIGS. 9A and 9B are diagrams illustrating a screen construction for generating personal information about an image included in a web based service screen according to an exemplary embodiment of the present invention; and

FIGS. 10A to 10C are diagrams illustrating a screen construction for starting a service corresponding to an image included in a web based service screen according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Below, a technology for providing a service by using an image recognition technology for a web based service screen in an electronic device is described according to exemplary embodiments of the present invention. Here, the web based service screen represents a screen constructed such that an electronic device provides a service by using data received online.

In the following description, the electronic device can be a device such as a portable electronic device capable of providing a web based service, a portable terminal, a mobile communication terminal, a Personal Digital Assistant (PDA), a laptop computer, a smart phone, a netbook, a TeleVision (TV), a Mobile Internet Device (MID), an Ultra Mobile Personal Computer (UMPC), a tablet PC, a desktop computer, a smart TV, a digital camera, a wrist watch, a navigator, an MPEG Audio Layer 3 (MP3) player, and the like. Also, wireless equipment may be any wireless equipment combining functions of two or more devices among the aforementioned devices.

In the following description, it is assumed that an electronic device executes an application program by using personal information matching a service image included in a web based service screen. Here, the service image includes a face image that is included in the web based service screen and a user image that is selected by a user to match the personal information.

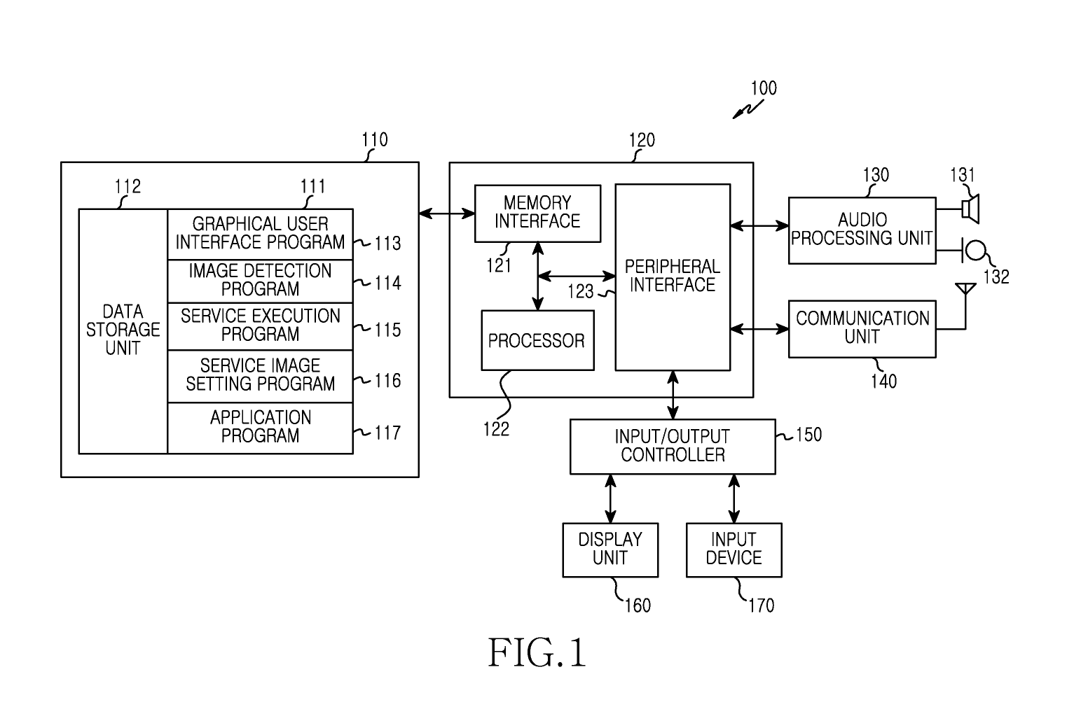

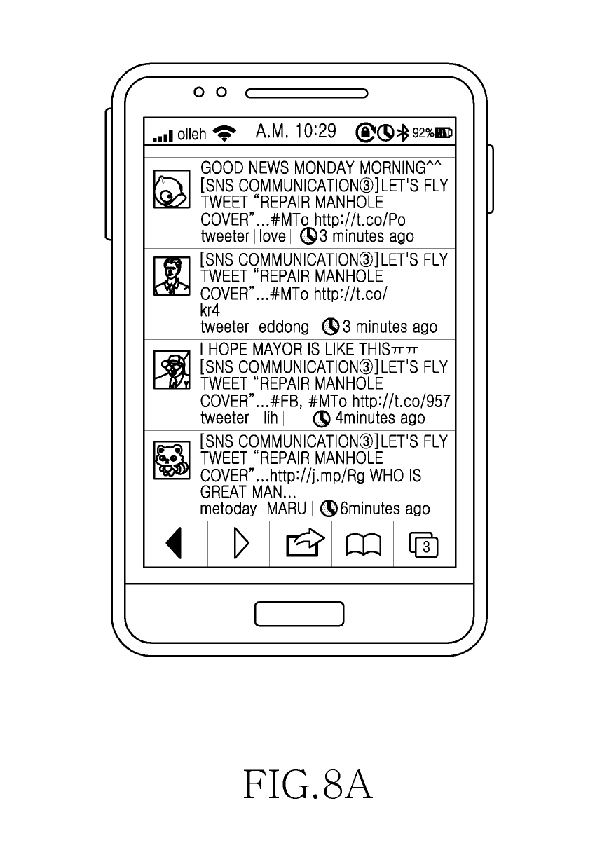

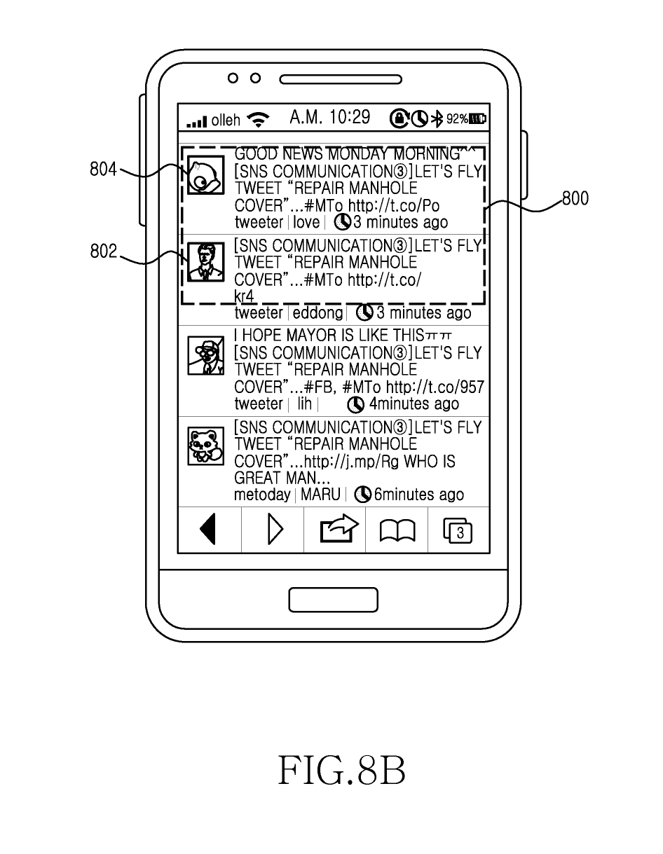

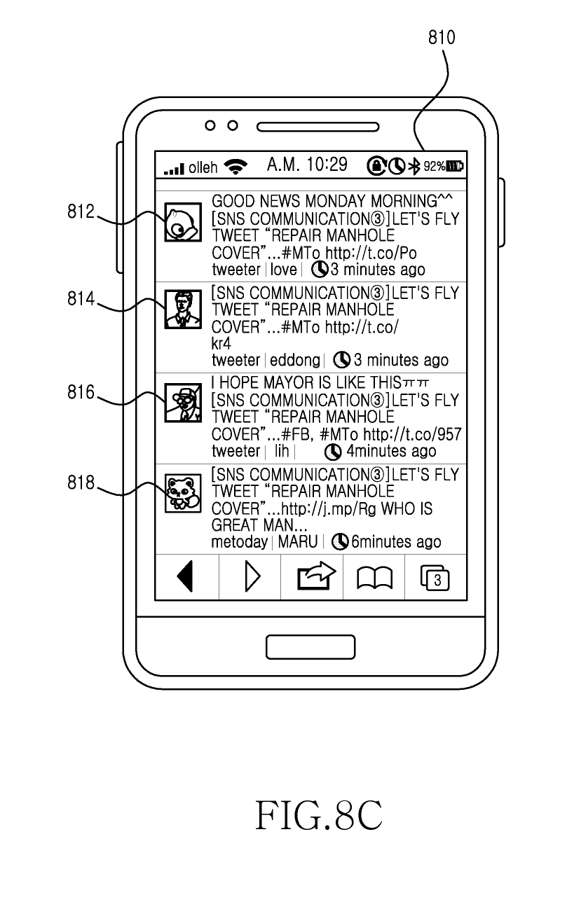

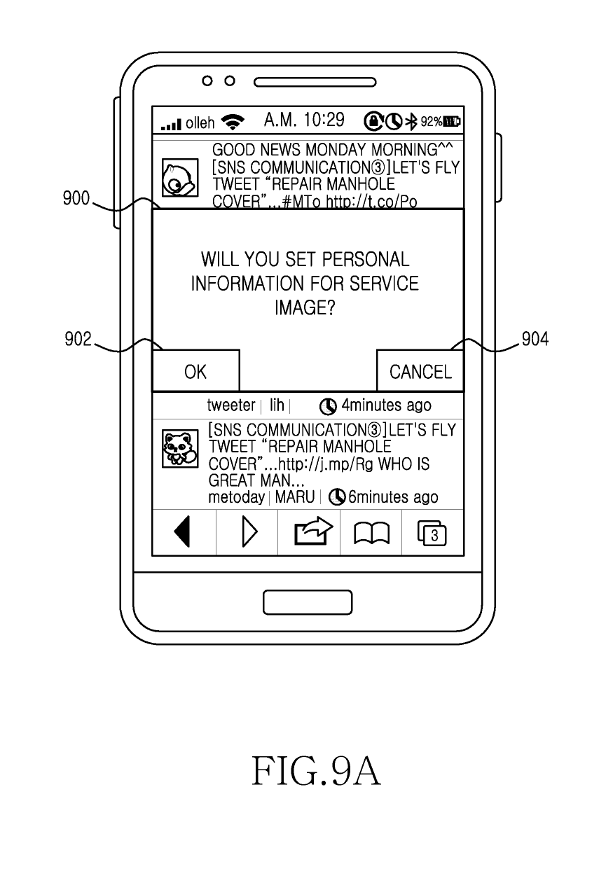

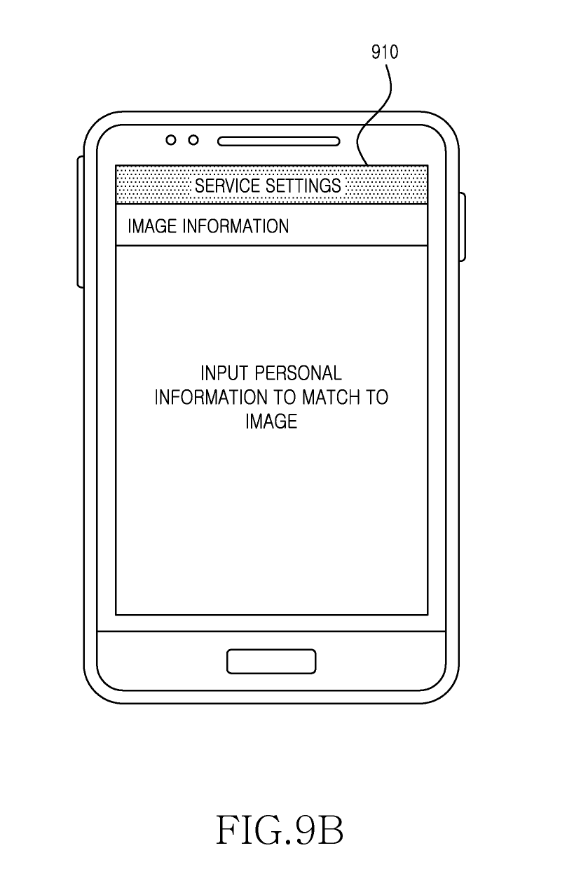

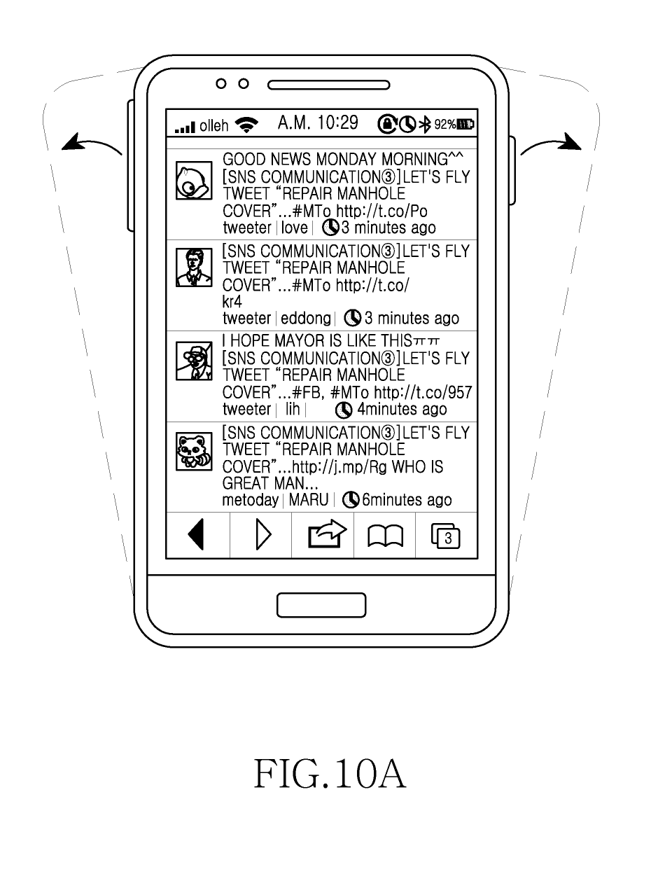

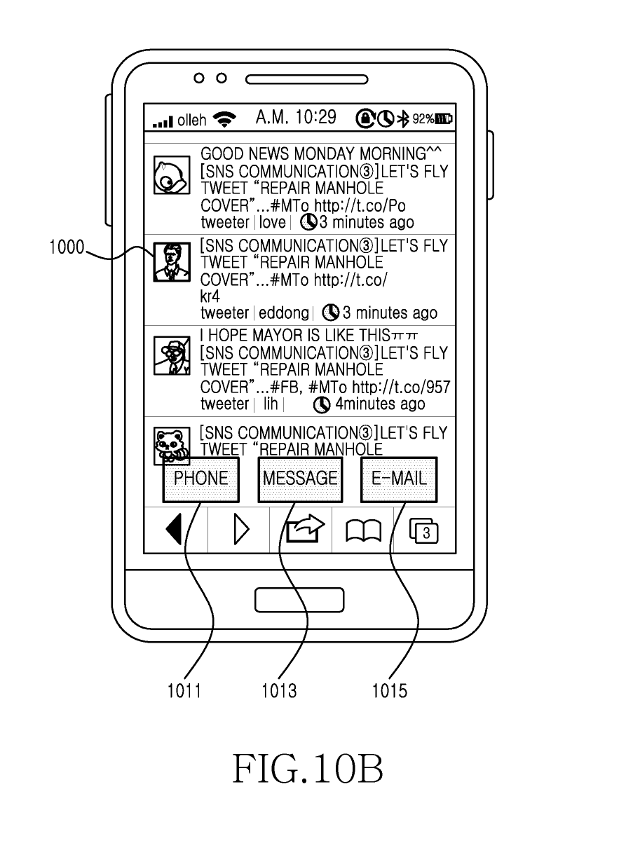

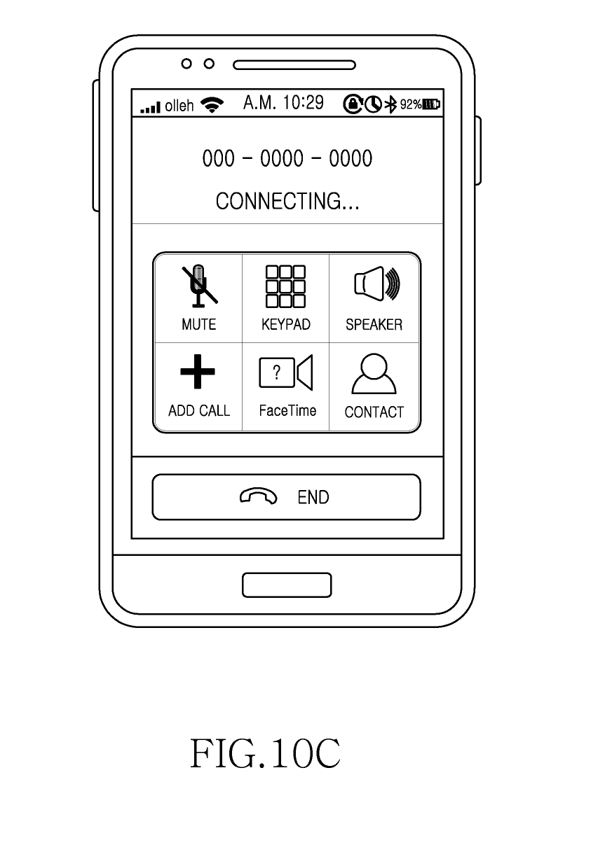

FIG. 1 is a block diagram illustrating a construction of an electronic device according to an exemplary embodiment of the present invention. FIGS. 8A to 8C are diagrams illustrating a screen construction for detecting an image in a web based service screen according to an exemplary embodiment of the present invention. FIGS. 9A and 9B are diagrams illustrating a screen construction for generating personal information about an image included in a web based service screen according to an exemplary embodiment of the present invention. FIGS. 10A to 10C are diagrams illustrating a screen construction for starting a service corresponding to an image included in a web based service screen according to an exemplary embodiment of the present invention.

As illustrated in FIG. 1, the electronic device 100 includes a memory 110, a processor unit 120, an audio processing unit 130, a communication unit 140, an input output controller 150, a display unit 160, and an input device 170. Here, the memory 110 and the communication unit 140 are illustrated as single elements but it is to be understood that there may be a plurality of memories 110 and communication units 140.

Each constituent element is described as follows.

The memory 110 includes a program storage unit 111 for storing programs for controlling operations of the electronic device 100 and a data storage unit 112 for storing data generated during program execution.

The data storage unit 112 stores at least one of data generated during program execution, a list of service images matching personal information, macro information for service execution, and the like. Here, the macro information includes a user's gesture for service execution, motion information of the electronic device and the like. Also, the personal information includes a user name matching a service image, a phone number, an electronic mail (e-mail) address and the like.

The program storage unit 111 includes a Graphical User Interface (GUI) program 113, an image detection program 114, a service execution program 115, a service image setting program 116, and at least one application program 117. Here, the program included in the program storage unit 111 is a set of instructions, and may be expressed as an instruction set.

The graphical user interface program 113 includes at least one software constituent element for providing a user interface using a graphic between a user and the electronic device 100. That is, the graphical user interface program 113 includes at least one software constituent element for displaying user interface information on the display unit 160. For example, as illustrated in FIG. 8A, the graphical user interface program 113 can control to display on the display unit 160 a service screen for a web based service received through the communication unit 140. For another example, as illustrated in FIG. 8B, the graphical user interface program 113 can control to display on the display unit 160 an image detection region 800 of the web based service screen. As another example, as illustrated in FIGS. 9A and 9B, the graphical user interface program 113 controls to display on the display unit 160 a screen for matching personal information to a service image. For yet another example, as illustrated in FIGS. 10A and 10B, the graphical user interface program 113 can control to display on the display unit 160 a screen for starting a service by using personal information matching a service image. Here, the image detection region is set by user input information received through the input device 170.

The image detection program 114 includes at least one software constituent element for extracting a service image from a web based service screen displayed on the display unit 160. For example, the image detection program 114 detects all images included in the web based service screen. After that, the image detection program 114 can extract a service image from the images detected in the web based service screen. For another example, the image detection program 114 may detect all images included in an image detection region among the web based service screen. Next, the image detection program 114 can extract a service image from the images detected in the image detection region. If failing to detect the image from the image detection region, the image detection program 114 may extract the image detection region as one service image.

The service execution program 115 includes at least one software constituent element for controlling to start a service by using personal information matching a service image extracted by the image detection program 114. For example, the service execution program 115 can determine if the service image extracted by the image detection program 114 is included in a service image list stored in the data storage unit 112. If the service image extracted by the image detection program 114 is not included in the service image list, the service execution program 115 can control to generate personal information for the service image extracted by the image detection program 114. Meanwhile, if the service image extracted by the image detection program 114 is included in the service image list, the service execution program 115 can start a service by using personal information matching the service image. At this time, the service execution program 115 can determine the kind of the service to start using the personal information matching the service image, in consideration of macro information stored in the data storage unit 112 or user selection information.

The service image setting program 116 includes at least one software constituent element for generating personal information for a service image. At this time, the service image setting program 116 generates the personal information for the service image according to the control of the service execution program 115. For example, according to user input information received from the input device 170, the service image setting program 116 can generate the personal information for the service image extracted in the image detection program 114. For another example, by extracting personal information included in a web based service screen, the service image setting program 116 may generate the personal information for the service image extracted in the image detection program 114. At this time, the personal information included in the web based service screen is extracted by the image detection program 114.

The application program 117 includes a software constituent element for at least one application program installed in the electronic device 100.

The processor unit 120 includes a memory interface 121, at least one processor 122, and a peripheral interface 123. Here, the memory interface 121 included in the processor unit 120, the at least one processor 122, and the peripheral interface 123 can be integrated as at least one integrated circuit or can be realized as separate constituent elements.

The memory interface 121 controls access of a constituent element, such as the processor 122 or the peripheral interface 123, to the memory 110.

The peripheral interface 123 controls connection of the processor 122 and the memory interface 121 with peripheral devices of the electronic device 100.

The processor 122 controls the electronic device 100 to provide various multimedia services by using at least one software program. At this time, the processor 122 controls to execute at least one program stored in the memory 110, providing a service corresponding to the executed program. For example, the processor 122 can include a display controller, an image detection unit, an image extraction unit, a service execution unit, a service image setting unit, and the like.

The display controller controls to execute the graphical user interface program 113 and provide a user interface using a graphic between a user and the electronic device 100. That is, the display controller controls to display user interface information on the display unit 160. For example, as illustrated in FIG. 8A, the display controller controls to display a service screen for a web based service received through the communication unit 140, on the display unit 160.

The image detection unit executes the image detection program 114 to detect an image in a web based service screen displayed on the display unit 160. For example, the image detection unit detects all images included in the web based service screen. For another example, the image detection unit may detect all images included in an image detection region among the web based service screen.

The image extraction unit executes the image detection program 114 to extract a service image from images detected in a web based service screen. For example, the image extraction unit extracts a service image from images detected in the web based service screen. For another example, the image extraction unit extracts a service image from images detected in an image detection region. If failing to detect the image in the image detection region, the image extraction unit may extract the image detection region as one service image.

The service execution unit executes the service execution program 115 to start a service by using personal information matching a service image extracted in the image extraction unit. For example, the service execution unit determines if a service image extracted in the image extraction unit is included in a service image list stored in the data storage unit 112. If the service image extracted in the image extraction unit is not included in the service image list, the service execution unit controls to generate personal information for a service image extracted in the image extraction unit. Meanwhile, if the service image extracted in the image extraction unit is included in the service image list, the service execution unit starts a service by using personal information matching the service image. At this time, the service execution unit can determine the kind of service executed using the personal information that matches the service image, in consideration of macro information stored in the data storage unit 112 or user selection information.

The service image setting unit executes the service image setting program 116 to generate personal information to match to a service image. At this time, the service image setting unit generates the personal information for the service image according to the control of the service execution unit.

The audio processing unit 130 provides an audio interface between a user and the electronic device 100 through a speaker 131 and a microphone 132.

The communication unit 140 processes a signal transmitted/received for voice communication and data communication. At this time, the communication unit 140 may be distinguished into a plurality of communication sub systems supporting different communication networks. For example, the communication network includes, although not limited to, a Global System for Mobile Communication (GSM) network, a Code Division Multiple Access (CDMA) network, a Wireless-Code Division Multiple Access (W-CDMA) network, a Long Term Evolution (LTE) network, an Orthogonal Frequency Division Multiple Access (OFDMA) network, a Wireless Local Area Network (WLAN), a Bluetooth network, Near Field Communication (NFC) and the like.

The input output controller 150 provides an interface between an input output device, such as the display unit 160, the input device 170 and the like, and the peripheral interface 123.

The display unit 160 displays status information of the electronic device 100, a character input by a user, a moving picture, a still picture, and the like. For example, the display unit 160 displays a web based service screen by the graphical user interface program 113.

The input device 170 provides input data generated by user's selection to the processor unit 120 through the input output controller 150. At this time, the input device 170 can include a keypad including at least one hardware button, a touch pad sensing a touch, and the like. For example, the input device 170 can provide touch information, which is sensed through the touch pad, to the processor unit 120 through the input output controller 150.

In the aforementioned exemplary embodiment, the electronic device 100 can execute the programs 113 to 116, which are stored in the program storage unit 111, through the processor 122, to start a service by using personal information matching a service image extracted from a web based service screen.

In another exemplary embodiment, the electronic device 100 may include a separate control module for controlling to start a service by using personal information matching a service image extracted from a web based service screen.

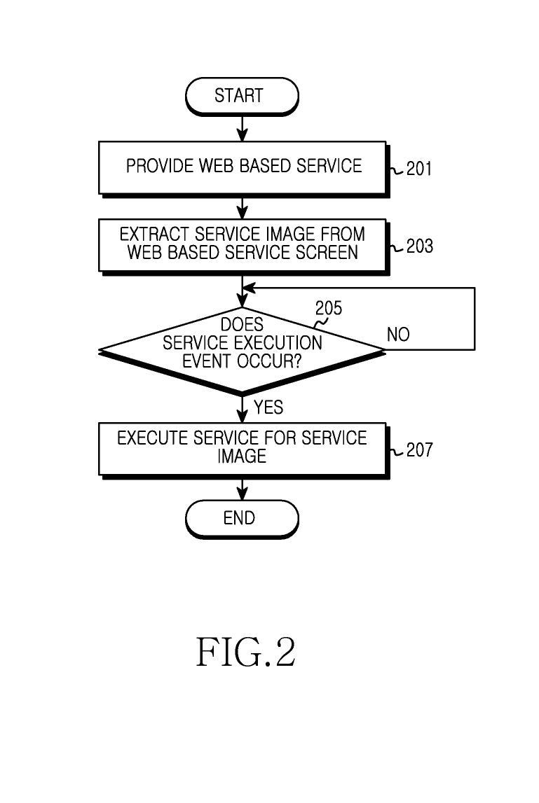

FIG. 2 illustrates a procedure for providing a service by using personal information matching an image according to an exemplary embodiment of the present invention.

Referring to FIG. 2, the electronic device provides a web based service in step 201. According to this, the electronic device can display a web based service screen, which is constructed using service data received through online, on the display unit 160. For example, if using a social networking service, the electronic device can display a social networking service screen on the display unit 160 as illustrated in FIG. 8A.

The electronic device extracts a service image from the web based service screen displayed on the display unit 160 in step 203. For example, as illustrated in FIG. 8B, the electronic device can detect images 802 and 804 in an image detection region 800. After that, the electronic device can extract a service image 802 from the images 802 and 804 detected in the image detection region 800. For another example, as illustrated in FIG. 8C, the electronic device may detect images 812, 814, 816, and 818 in a web based service screen 810. After that, the electronic device may extract a service image 814 from the images 812, 814, 816, and 818 detected in the web based service screen 810.

The electronic device determines if a service execution event occurs in step 205. For example, the electronic device can determine if macro information for service execution is sensed. For another example, the electronic device may determine if a user selects a service for executing.

If it is determined in step 205 that the service execution event occurs, the electronic device starts a service by using personal information matching the service image in step 207. At this time, the electronic device can determine the kind of the service to start using the personal information matching the service image according to the kind of the service execution event. For example, if left/right shaking is sensed as illustrated in FIG. 10A, the electronic device can attempt call connection as illustrated in FIG. 10C by using the personal information matching the service image extracted in step 203, according to the macro information. For another example, as illustrated in FIG. 10B, the electronic device may display ‘phone’ 1011, ‘message’ 1013, and ‘e-mail’ 1015 as a list of services that are executable using the personal information matching the service image 1000 extracted in step 203, on the display unit 160. If ‘phone’ 1011 is selected by a user, as illustrated in FIG. 10C, the electronic device can attempt call connection by using the personal information matching the service image extracted in step 203.

Next, the electronic device terminates the algorithm of the present invention.

As described above, an exemplary electronic device provides a service by using personal information matching a service image extracted from a web based service screen. At this time, the electronic device can be constructed by at least one means for performing each process for providing the service by using the personal information matching the service image illustrated in FIG. 2.

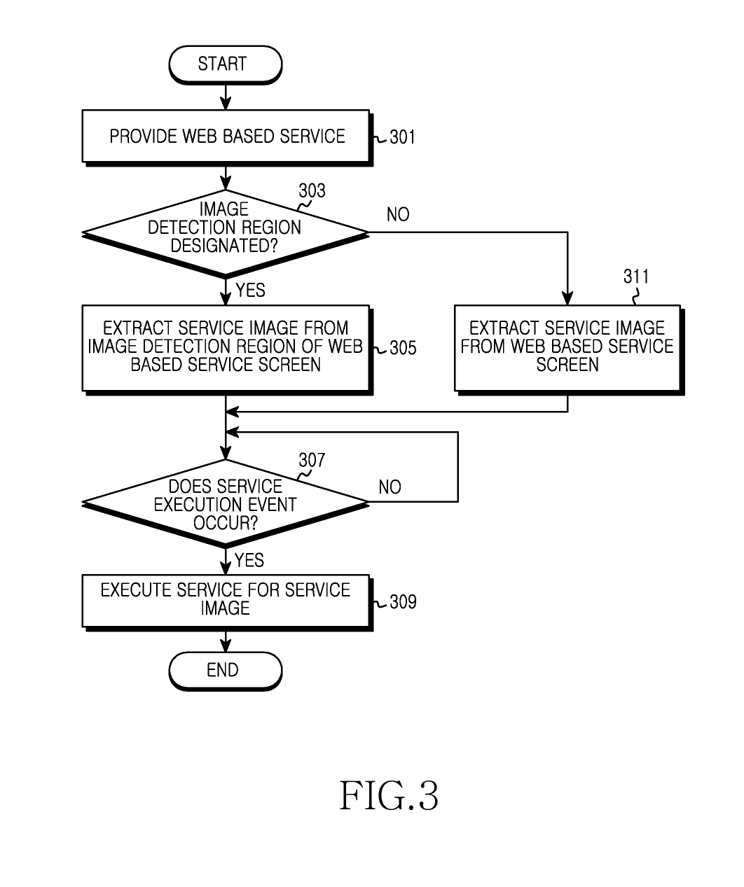

FIG. 3 illustrates a procedure for detecting an image in a web based service screen according to the first exemplary embodiment of the present invention.

Referring to FIG. 3, the electronic device provides a web based service in step 301. According to this, the electronic device can display a web based service screen, which is constructed using service data received online, on the display unit 160. For example, if using a social networking service, the electronic device can display a social networking service screen on the display unit 160 as illustrated in FIG. 8A.

The electronic device determines if an image detection region is designated among a web based service screen in step 303. For example, the electronic device can determine if user's input information for setting the image detection region is sensed through the input device 170.

If it is determined in step 303 that the image detection region is designated, the electronic device proceeds extracts a service image from the image detection region of the web based service screen in step 305. For example, if an image detection region 800 is set to a web based service screen as illustrated in FIG. 8B, the electronic device can detect images 802 and 804 in the image detection region 800. After that, the electronic device can extract a service image 802 from the images 802 and 804 detected in the image detection region 800. If failing to detect an image in the image detection region 800, the electronic device may recognize the image detection region 800 as a service image.

Meanwhile, if it is determined in step 303 that the image detection region is not designated, the electronic device extracts a service image from the web based service screen in step 311. For example, as illustrated in FIG. 8C, the electronic device can detect images 812, 814, 816, and 818 from the web based service screen 810. After that, the electronic device can extract a service image 814 from the images 812, 814, 816, and 818 detected in the web based service screen 810.

In step 307, the electronic device determines if a service execution event occurs. For example, the electronic device can determine if macro information for service execution is sensed. For another example, the electronic device may determine if a user selects a service for executing.

If it is determined in step 307 that the service execution event occurs, the electronic device starts a service by using personal information matching the service image in step 309. At this time, the electronic device determines the kind of the service to start using the personal information matching the service image according to the kind of the service execution event. For example, if left/right shaking is sensed as illustrated in FIG. 10A, the electronic device can attempt call connection as illustrated in FIG. 10C by using the personal information matching the service image, according to the macro information. For another example, as illustrated in FIG. 10B, the electronic device may display ‘phone’ 1011, ‘message’ 1013, and ‘e-mail’ 1015 as a list of services that are executable using the personal information matching the service image, on the display unit 160. If ‘phone’ 1011 is selected by a user, as illustrated in FIG. 10C, the electronic device can attempt call connection by using the personal information matching the service image.

Next, the electronic device terminates the algorithm of the present invention.

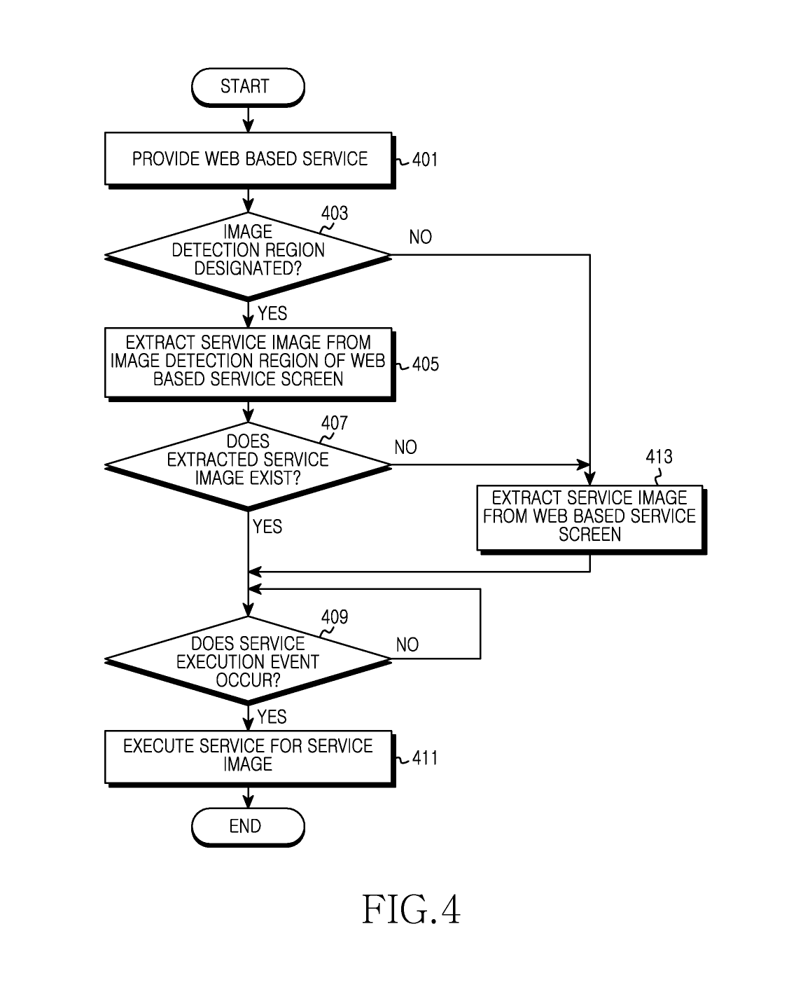

FIG. 4 illustrates a procedure for detecting an image in a web based service screen according to the second exemplary embodiment of the present invention.

Referring to FIG. 4, the electronic device provides a web based service in step 401. According to this, the electronic device can display a web based service screen, which is constructed using service data received online, on the display unit 160. For example, if using a social networking service, the electronic device can display a social networking service screen on the display unit 160 as illustrated in FIG. 8A.

The electronic device determines if an image detection region is designated among a web based service screen in step 403. For example, the electronic device can determine if user's input information for setting the image detection region is sensed through the input device 170.

If it is determined in step 403 that the image detection region is not designated, the electronic device extracts a service image from the web based service screen in step 413. For example, as illustrated in FIG. 8C, the electronic device can detect images 812, 814, and 816, and 818 from the web based service screen 810. After that, the electronic device can extract a service image 814 from the images 812, 814, 816, and 818 detected in the web based service screen 810.

If it is determined in step 403 that the image detection region is designated, the electronic device extracts a service image from the image detection region of the web based service screen in step 405. For example, if an image detection region 800 is set to a web based service screen as illustrated in FIG. 8B, the electronic device can detect images 802 and 804 in the image detection region 800. After that, the electronic device can extract a service image 802 from the images 802 and 804 detected in the image detection region 800.

In step 407, the electronic device determines if the service image extracted from the image detection region 800 exists.

If it is determined in step 407 that the service image extracted from the image detection region 800 does not exist, the electronic device extracts the service image from the web based service screen in step 413.

If it is determined in step 407 that the service image extracted from the image detection region 800 exists, the electronic device determines if a service execution event occurs in step 409. For example, the electronic device can determine if macro information for service execution is sensed. For another example, the electronic device may determine if a user selects a service for executing.

If it is determined in step 409 that the service execution event occurs, the electronic device starts a service by using personal information matching the service image in step 411. At this time, the electronic device can determine the kind of the service to start using the personal information matching the service image according to the kind of the service execution event. For example, if left/right shaking is sensed as illustrated in FIG. 10A, the electronic device can attempt call connection as illustrated in FIG. 10C by using the personal information matching the service image, according to the macro information. For another example, as illustrated in FIG. 10B, the electronic device may display ‘phone’ 1011, ‘message’ 1013, and ‘e-mail’ 1015 as a list of services that are executable using the personal information matching the service image, on the display unit 160. If ‘phone’ 1011 is selected by a user, as illustrated in FIG. 10C, the electronic device can attempt call connection by using the personal information matching the service image.

Next, the electronic device terminates the algorithm of the present invention.

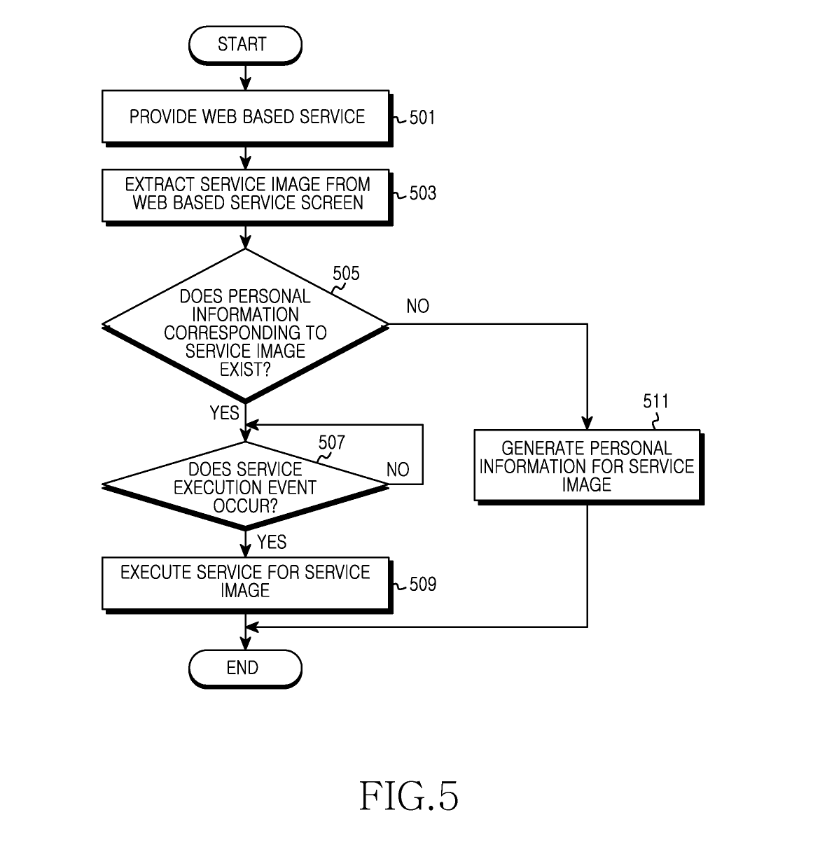

FIG. 5 illustrates a procedure for generating personal information about an image included in a web based service screen according to an exemplary embodiment of the present invention.

Referring to FIG. 5, the electronic device provides a web based service in step 501. According to this, the electronic device can display a web based service screen, which is constructed using service data received through online, on the display unit 160. For example, if using a social networking service, the electronic device can display a social networking service screen on the display unit 160 as illustrated in FIG. 8A.

The electronic device extracts a service image from the web based service screen displayed on the display unit 160 in step 503. For example, as illustrated in FIG. 8B, the electronic device can detect images 802 and 804 in an image detection region 800. After that, the electronic device can extract a service image 802 from the images 802 and 804 detected in the image detection region 800. For another example, as illustrated in FIG. 8C, the electronic device can detect images 812, 814, and 816, and 818 from the web based service screen 810. After that, the electronic device can extract a service image 814 from the images 812, 814, 816, and 818 detected in the web based service screen 810.

The electronic device determines if personal information matching the service image exists in step 505. For example, the electronic device can determine if the service image extracted in step 503 is included in a service image list stored in the data storage unit 112.

If the service image extracted in step 503 is not included in the service image list stored in the data storage unit 112, the electronic device recognizes that personal information matching the service image does not exist. According to this, the electronic device generates personal information to match to the extracted service image in step 511.

If the extracted service image is included in the service image list stored in the data storage unit 112, the electronic device recognizes that the personal information matching the service image exists. According to this, the electronic device can determine if a service execution event occurs in step 507. For example, the electronic device determines if macro information for service execution is sensed. For another example, the electronic device may determine if a user selects a service for executing.

If it is determined in step 507 that the service execution event occurs, the electronic device starts a service by using the personal information matching the service image in step 509. At this time, the electronic device can determine the kind of the service to start using the personal information matching the service image according to the kind of the service execution event. For example, if left/right shaking is sensed as illustrated in FIG. 10A, the electronic device can attempt call connection as illustrated in FIG. 10C by using the personal information matching the service image extracted in step 503, according to the macro information. For another example, as illustrated in FIG. 10B, the electronic device may display ‘phone’ 1011, ‘message’ 1013, and ‘e-mail’ 1015 as a list of services that are executable using the personal information matching the service image extracted in step 503, on the display unit 160. If ‘phone’ 1011 is selected by a user, as illustrated in FIG. 10C, the electronic device can attempt call connection by using the personal information matching the service image extracted in step 503.

Next, the electronic device terminates the algorithm of the present invention.

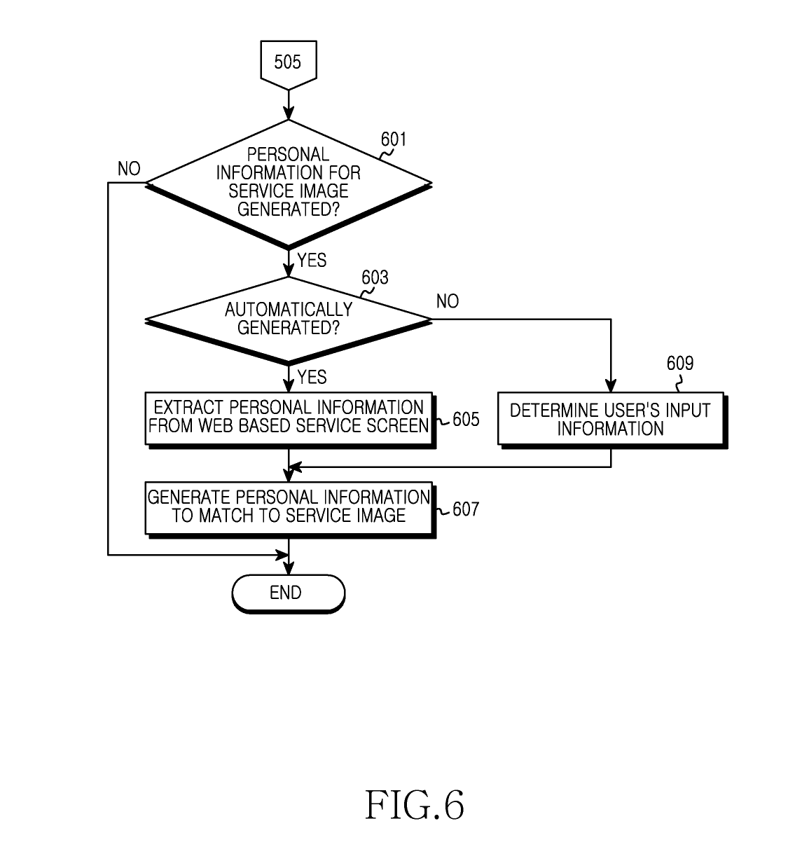

In the aforementioned exemplary embodiment, if personal information matching a service image does not exist, the electronic device can generate personal information about a corresponding service image in step 511. At this time, if the personal information matching the service image does not exist, the electronic device may selectively generate personal information about a corresponding service image as illustrated in FIG. 6.

FIG. 6 illustrates a detailed procedure for generating personal information about an image included in a web based service screen according to an exemplary embodiment of the present invention.

Referring to FIG. 6, if personal information matching a service image does not exist in step 505 of FIG. 5, the electronic device determines whether to generate personal information for the extracted service image in step 601. For example, if the personal information matching the service image does not exist, the electronic device can display a control screen 900 for determining generation or non-generation of the personal information for the service image, on the display unit 160 as illustrated in FIG. 9A. If selection of ‘OK’ 902 is sensed in the control screen 900, the electronic device can recognize that it generates the personal information for the service image. Meanwhile, if selection for ‘cancel’ 904 is sensed in the control screen 900, the electronic device may recognize that it does not generate the personal information for the service image.

If it is determined in step 601 not to generate the personal information for the service image, the electronic device terminates the algorithm of the present invention.

Meanwhile, if it is determined to generate the personal information for the service image, the electronic device determines whether to automatically generate the personal information for the service image in step 603. For example, the electronic device can determine whether to automatically generate the personal information for the service image in consideration of preset automatic generation setting information.

If it is determined not to automatically generate the personal information for the service image, the electronic device determines a user's input information in step 609. For example, if it is determined not to automatically generate the personal information for the service image, the electronic device can display an input screen 910 for the personal information for the service image, on the display unit 160 as illustrated in FIG. 9B. Next, the electronic device can determine user input information input through the personal information input screen 910.

The electronic device generates the personal information for the service image by using the user input information in step 607. That is, the electronic device matches the personal information generated using the user input information, to the service image. In this case, the electronic device adds the service image matching the personal information, to a service image list.

Meanwhile, if it is determined to automatically generate the personal information for the service image, the electronic device extracts the personal information from a web based service screen in step 605. For example, the electronic device can extract a homepage address (e.g., “http://t.co/”) of a service image 814 and an IDentifier (ID) (e.g., ‘eddong’) from a web based service screen illustrated in FIG. 8C.

The electronic device matches the personal information extracted from the web based service screen, to the service image in step 607. In this case, the electronic device can add the service image matching the personal information, to the service image list.

After that, the electronic device terminates the algorithm of the present invention.

In the aforementioned exemplary embodiment, the electronic device can determine whether to automatically generate personal information for a service image in consideration of preset automatic generation setting information.

In another exemplary embodiment, the electronic device may determine whether to automatically generate the personal information for the service image depending on whether the personal information is extracted from a web based service screen. For example, if it is determined to generate personal information for a service image in step 601, the electronic device can extract the personal information from the web based service screen in step 605. If extracting the personal information from the web based service screen, the electronic device can match the personal information extracted from the web based service screen, to the service image in step 607. Meanwhile, if not extracting the personal information from the web based service screen, the electronic device can recognize that it cannot automatically generate the personal information for the service image. According to this, the electronic device can generate the personal information for the service image in consideration of user's input information in step 609 and step 607.

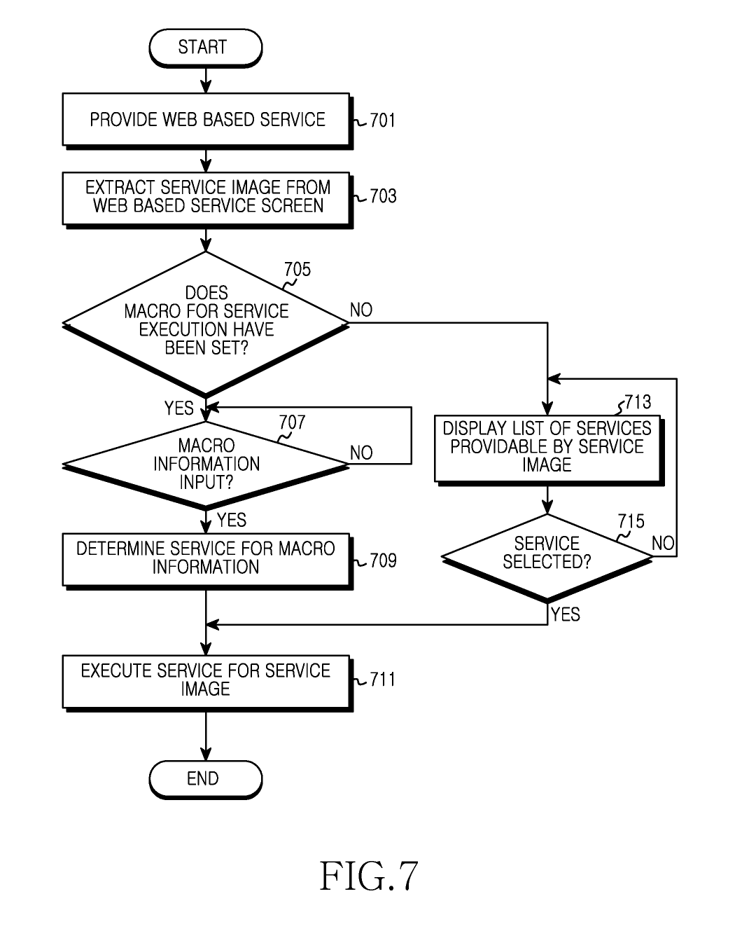

FIG. 7 illustrates a procedure for starting a service for image information by using macro information according to an exemplary embodiment of the present invention.

Referring to FIG. 7, an electronic device provides a web based service in step 701. According to this, the electronic device can display a web based service screen constructed using service data received online, on the display unit 160. For example, if a user uses a social networking service, the electronic device can display a social networking service screen on the display unit 160 as illustrated in FIG. 8A.

The electronic device extracts a service image from the web based service screen displayed on the display unit 160 in step 703. For example, as illustrated in FIG. 8B, the electronic device can detect images 802 and 804 in an image detection region 800. After that, the electronic device can extract a service image 802 from the images 802 and 804 detected in the image detection region 800. For another example, as illustrated in FIG. 8C, the electronic device can detect images 812, 814, 816, and 818 in a web based service screen 810. After that, the electronic device may extract a service image 814 from the images 812, 814, 816, and 818 detected in the web based service screen 810.

The electronic device determines if a macro for service execution has been set in step 705.

If it is determined in step 705 that the macro for the service execution has been set, the electronic device determines if macro information is input in step 707. In other words, the electronic device can determine if a user's gesture capable of matching service execution or a motion of the electronic device is sensed.

If it is determined in step 707 that the macro information is input, the electronic device proceeds to step 709 and determines a service matching the macro information.

The electronic device starts the service matching the macro information by using personal information matching a service image in step 711. For example, if left/right shaking is sensed as illustrated in FIG. 10A, the electronic device can attempt call connection by using personal information matching the service image extracted in step 703 as illustrated in FIG. 10C.

Meanwhile, if it is determined in step 705 that the macro for the service execution has not been set, the electronic device displays a list of services capable of starting using personal information matching the service image in step 713. For example, as illustrated in FIG. 10B, the electronic device can display ‘phone’ 1011, ‘message’ 1013, and ‘e-mail’ 1015 as a list of services capable of starting using personal information matching the service image extracted in step 703, on the display unit 160.

The electronic device determines if any one service is selected from the service list in step 715.

If the service is not selected, the electronic device returns to step 713 and displays a list of services capable of starting using the personal information matching the service image. If the service is not selected during a reference time, the electronic device may eliminate the service list displayed on the display unit 160.

Meanwhile, if the service to start using the personal information matching the service image is selected, the electronic device starts the service that is selected in the service list by using the personal information matching the service image in step 711. For example, if ‘phone’ 1011 is selected in the service list illustrated in FIG. 10B, the electronic device can attempt call connection by using the personal information matching the service image extracted in step 703 as illustrated in FIG. 10C.

Next, the electronic device terminates the algorithm of the present invention.

As described above, an electronic device provides a service by using image information matching an image of a web based service screen, whereby a user of the electronic device can share information quickly by using a web based service, and can drive various supplementary services together with the web based service.

It will be appreciated that exemplary embodiments of the present invention according to the claims and description in the specification can be realized in the form of hardware, software or a combination of hardware and software.

Any such software may be stored in a computer readable storage medium. The computer readable storage medium stores one or more programs (software modules), the one or more programs comprising instructions, which when executed by one or more processors in an electronic device, cause the electronic device to perform a method of the present invention.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are exemplary embodiments of machine-readable storage that are suitable for storing a program or programs comprising instructions that, when executed, implement exemplary embodiments of the present invention. Accordingly, exemplary embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and exemplary embodiments suitably encompass the same.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for providing a service in an electronic device, the method comprising:
constructing a service screen;
extracting an image from the service screen;
determining personal information matching the extracted image; and
executing an application program by using the personal information matching the image.

2. The method of claim 1, wherein the extracting of the image comprises:
determining a detection region for image detection in the service screen; and
detecting an image in the detection region.

3. The method of claim 2, further comprising, if not detecting the image in the detection region, recognizing the detection region as one image.

4. The method of claim 1, wherein the image comprises at least one of a face image and a user image that is selected by a user.

5. The method of claim 1, wherein the personal information comprises user identification information comprising at least one of a name, a phone number, and an electronic mail (e-mail) address.

6. The method of claim 1, wherein the determining of the service information matching the image comprises:
determining if at least one matching image matching the image extracted from the service screen exists among at least one matching image matching personal information; and
if the at least one matching image matching to the image extracted from the service screen exists, determining personal information matching the matching image.

7. The method of claim 6, further comprising, if the matching image matching the image extracted from the service screen does not exist among the at least one matching image, determining personal information to match to the image extracted from the service screen.

8. The method of claim 7, wherein the determining of the personal information comprises:
detecting personal information matching the image, in the service screen; and
matching the detected personal information to the image extracted from the service screen.

9. The method of claim 1, wherein the executing of the application program comprises:
if macro information is sensed, determining an application program matching the macro information; and
executing the application program by using the personal information matching the image,
wherein the macro information comprises at least one of a user's gesture and a motion of the electronic device.

10. The method of claim 1, wherein the executing of the application program comprises:
displaying at least one application program executable using the personal information matching the image; and
if any one application program is selected among the at least one application program, executing the selected application program by using the personal information matching the image.

11. An electronic device comprising:
at least one processor for executing computer programs;
a memory for storing data and instructions; and
at least one program stored in the memory and configured to be executable by the at least one processor,
wherein the program constructs a service screen,
extracts an image from the service screen,
determines personal information matching the extracted image, and
executes an application program by using the personal information matching the image.

12. The device of claim 11, wherein the program determines a detection region for image detection in the service screen, and detects an image in the detection region.

13. The device of claim 12, wherein, if not detecting the image in the detection region, the program recognizes the detection region as one image.

14. The device of claim 11, wherein the image comprises at least one of a face image and a user image that is selected by a user.

15. The device of claim 12, wherein the personal information comprises user identification information comprising at least one of a name, a phone number, and an electronic mail (e-mail) address.

16. The device of claim 11, wherein the program
determines if a matching image matching the image extracted from the service screen exists among at least one matching image matching personal information, and
if the matching image matching the image extracted from the service screen exists, determines personal information matching the matching image.

17. The device of claim 16, wherein, if the matching image matching the image extracted from the service screen does not exist among the at least one matching image, the program determines personal information to match to the image extracted from the service screen.

18. The device of claim 17, wherein the program
detects personal information matching the image, in the service screen, and
matches the detected personal information to the image extracted from the service screen.

19. The device of claim 11, wherein the program
if macro information is sensed, determines an application program matching the macro information, and
executes the application program by using the personal information matching the image,
wherein the macro information comprises at least one of a user's gesture and a motion of the electronic device.

20. The device of claim 11, wherein the program
displays at least one application program executable using the personal information matching the image, and
if any one application program is selected among the at least one application program, executes the selected application program by using the personal information matching the image.
